(19) United States
(12) Patent Application Publication
(10) Pub. No.: US 2005/0205740 A1
(43) Pub. Date: Sep. 22, 2005

(54) Adjustable beverage holder

(76) Inventor: Alan Sturt, West Bloomfield, MI (US)

Correspondence Address: MACMILLAN, SOBANSKI & TODD, LLC, ONE MARITIME PLAZA-FOURTH FLOOR, 720 WATER STREET, TOLEDO, OH, 43604, US

(21) Appl. No.: 10/802,905

(22) Filed: Mar. 17, 2004

(51) Int. Cl. G11B 7/00

(52) U.S. Cl. 248/311.2

(57) ABSTRACT

A holder for supporting an article in a vehicle includes a housing having a support surface for supporting an article, wherein the housing defines a vertical axis. A plurality of leaf members is movably mounted relative to the housing. Each leaf member has an end defining a contact surface for laterally supporting the article. The leaf members are movable between a first position and a second position, such that when the leaf members are moved from the first position to the second position, the contact surfaces are caused to move relatively away from one another.

### BACKGROUND OF THE INVENTION

This invention relates to a holder for supporting an article. More particularly, the invention relates to a beverage holder for supporting a beverage container in a vehicle.

Vehicle interiors typically include a variety of decorative and functional trim panels. For example, the front area of the interior of a vehicle, generally referred to as the cockpit area, includes an instrument panel, typically formed of a molded plastic material. Vehicles also may include a center console located between the driver and passenger seats for storage and placement of various articles. The instrument panel and/or center console can include a variety of devices for holding beverage containers, typically known as cup holders. Known cup holders typically are adapted to hold known beverage containers, such as cans, cups, and bottles. However, known cup holders generally can be used for only a limited number of sizes of containers. It would be advantageous if there could be developed an improved beverage holder for supporting a greater number of beverage container sizes.

### SUMMARY OF THE INVENTION

The present invention relates to a holder for supporting an article in a vehicle. The holder includes a housing having a support surface for supporting an article, wherein the housing defines a vertical axis. A plurality of leaf members is movably mounted relative to the housing. Each leaf member has an end defining a contact surface for laterally supporting the article. The leaf members are movable between a first position and a second position, such that when the leaf members are moved from the first position to the second position, the contact surfaces are caused to move relatively away from one another.

Other advantages of this invention will become apparent to those skilled in the art from the following detailed description of the invention, when read in light of the accompanying drawings.

### BRIEF DESCRIPTION OF THE DRAWINGS

FIG. 1 is a perspective view of a portion of a vehicle floor console showing the first and the third embodiments of the beverage holder according to the invention.

FIG. 2 is a cross sectional plan view of the first embodiment of the beverage holder illustrated in FIG. 1, showing the beverage holder in the closed position.

FIG. 3 is a cross sectional plan view of the first embodiment of the beverage holder illustrated in FIG. 1, showing the beverage holder in the open position.

FIG. 4 is a perspective view of the second embodiment of the beverage holder according to the invention.

FIG. 5 is a top plan view of the frame illustrated in FIG. 4, showing two leaf members.

FIG. 6 is a perspective view of a portion of the body portion of the body portion of the beverage holder illustrated in FIGS. 1 through 3.

FIG. 7 is a bottom plan view of the leaf member illustrated in FIGS. 4 and 5.

FIG. 8 is a perspective view of a portion of the frame illustrated in FIG. 5, showing a slot.

FIG. 9 is a cross sectional plan view of the second embodiment of the beverage holder illustrated in FIG. 4, showing the beverage holder in the closed position.

FIG. 9A is a cross sectional plan view of an alternate embodiment of the body portion and the leaf member illustrated in FIG. 9.

FIG. 10 is a cross sectional plan view of the second embodiment of the beverage holder illustrated in FIG. 4, showing the beverage holder in the open position.

FIG. 11 is a cross sectional plan view of the third embodiment of the beverage holder illustrated in FIG. 1, showing the beverage holder in the closed position.

FIG. 12 is a top plan view of the adjusting ring illustrated in FIG. 11.

FIG. 13 is a bottom perspective view of the leaf member illustrated in FIG. 11.

FIG. 14 is a cross sectional plan view of the third embodiment of the beverage holder illustrated in FIG. 1, showing the beverage holder in the open position.

### DETAILED DESCRIPTION OF THE INVENTION

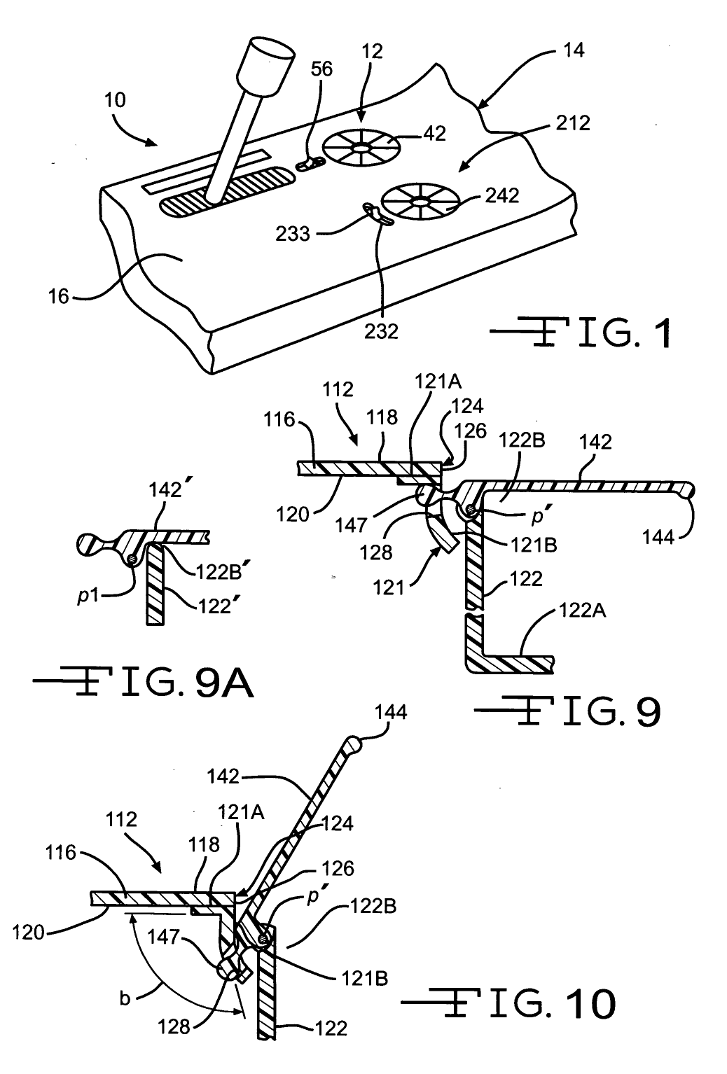

Referring now to the drawings, there is illustrated in FIG. 1, a floor console, indicated generally at 10. The floor console 10 is an example of a trim panel for mounting in an interior cabin of a vehicle. It will be appreciated however, that the floor console 10 of the subject invention may be any type of trim panel associated with a vehicle. Other suitable examples of trim panels include instrument panels, door panels, center consoles, overhead consoles, and other various interior panels for covering the sides, ceilings, and/or vertical pillars of the frame members of the vehicle.

As shown in FIG. 1, a first embodiment of an adjustable beverage holder for supporting an article according to the invention is illustrated generally at 12. An alternate embodiment of the adjustable beverage holder for supporting an article is illustrated generally at 212 and will be described in detail herein. The beverage holder 12 includes a housing 14 adapted to be mounted within a vehicle, such as an automobile, a boat, or an airplane.

The housing 14 may be of any desired type and located at any desired position in the vehicle. The housing 14 may be attached to the vehicle by any desired means, such as threaded fasteners, by welding, or with adhesive. Alternately, the housing 14 may be mounted in a drawer-type beverage holder. It will be appreciated that the housing 14 can also be attached to any portion of a vehicle where a beverage holder is desired.

As best shown in FIG. 2, the housing 14 preferably includes a substrate or housing portion 16 having an ornamental or decorative surface 18 and an underside 20, and a body portion 22. As best shown in FIG. 2, the housing portion 16 includes an inner surface 24 defining a housing opening 26 having a vertical axis A. Preferably, the housing opening 26 is substantially cylindrical in shape, although such is not required. The housing opening 26 can also have any other desired shape. A circumferentially extending groove 28 is formed in the inner surface 24 and defines a first camming surface 30. If desired, an actuator opening 32 can be formed in the housing portion 16. Preferably, the actuator opening 32 is formed adjacent the housing opening 26, as shown in FIGS. 1 through 3. The housing portion 16 can be formed from any desired substantially rigid material, such as plastic. Polypropylene, nylon, acrylonitrile butadiene styrene (ABS), and polycarbonate acrylonitrile butadiene styrene (PCABS) are preferred materials for the housing portion 16 because of their strength and rigidity.

The body portion 22 is disposed within the housing opening 26. The body portion 22 is preferably substantially cup shaped having a support surface 22A for horizonally supporting an object, such as a beverage container (as shown by a phantom line 34 in FIG. 3), and an open end 22B opposite the support surface 22A. As best shown in FIG. 6, a plurality of pivot bosses 36 extend axially outwardly from the open end 22B of the body portion 22. The bosses 36 include a first bore 36A for receiving a first pivot pin 38. A third pivot pin 40 is attached to a downwardly extending (as viewed in FIG. 2) portion 22C of the body portion 22. As will be explained herein, the body portion 22 is movable relative to the housing portion 16. Preferably, the body portion 22 is axially movable relative to the housing portion 16. The body portion 22 can be formed from any desired substantially rigid material, such as plastic. Polypropylene, nylon, ABS, and PCABS are preferred materials for the body portion 22 because of their strength and rigidity.

A plurality of leaf members 42 is movably mounted about the open end 22B of the body portion 22. Preferably, the leaf members 42 are pivotally mounted about the open end 22B of the body portion 22, such that each leaf member 42 is disposed adjacent to another of the leaf members 42, as best shown in FIG. 1. Each leaf member 42 includes a first end 42A defining a contact surface 44 for laterally supporting an object, such as the container 34, and a second end 42B opposite the first end 42A. The second end 42B defines a second camming surface 46. Preferably, the second ends 42B of the leaf members 42 are disposed within the groove 28.

Preferably, the leaf members 42 have the shape of a truncated triangle, as best shown in FIGS. 1 and 6. It will be understood however, that the leaf members 42 can have any desired shape, such as a substantially rectangular shape. A second bore 48 is formed in the leaf member 42 adjacent the second end 42B. The second bore 48 defines a pivot axis P. Preferably, the leaf members 42 are movable between a first or closed position as shown in FIG. 2 and a second or open position, as shown in FIG. 3. Preferably, the contact surfaces 44 of oppositely disposed leaf members 42 are spaced apart a distance D1 when in the first position. When in the first position, the leaf members preferably define a substantially horizontal surface, as best shown in FIG. 2. The leaf members 42 can be formed from any desired substantially rigid material, such as plastic. Polypropylene, nylon, ABS, and PCABS are preferred materials for the leaf members 42 because of their strength and rigidity.

An actuating mechanism 50 is disposed between the housing portion 16 and the body portion 22. The actuating mechanism 50 includes a sliding member 52 having a lower surface 52A and an upwardly facing (as viewed in FIG. 2) handle portion 56. The lower surface has a plurality of downwardly facing (as viewed in FIG. 2) grooves or indentations 54 formed therein. A substantially V-shaped actuating arm 58 includes a first end 58A and a second end 58B, and is pivotally connected to a portion (not shown) of the vehicle by a second pivot pin 60. The first end 58A includes a sliding surface 62 for frictionally engaging the indentations 54 of the sliding member 52. The second end 58B includes a slot 64 for receiving the third pivot pin 40. The second end 58B is slidably and pivotally connected to the body portion 22 by the third pivot pin 40.

In operation, a force is applied to the handle portion 56, causing the sliding member 52 to move in the direction of an arrow 66. The sliding surface 62 of the actuating arm 58 is then caused to slide along the lower surface 52A of the sliding member 52 in the direction of an arrow 67, further causing the actuating arm to pivot about the second pivot pin 60. The slot 64 then slides about the third pivot pin 40 as the second end 58B of the actuating arm 58 urges the body portion 22 upwardly from the first position, as viewed in FIG. 2, to the second position, as viewed in FIG. 3.

As the body portion 22 moves upwardly, the second camming surface 46 of the leaf members 42 engages the first camming surface 30 of the groove 28. The leaf members 42 are then caused to pivot about the first pivot pins 38, further causing the contact surfaces 44 to move vertically upwardly to the second position, as shown in FIG. 3. Preferably, the leaf members 42 move substantially simultaneously. As used herein, the term vertically is defined as transverse to the substantially horizontal surface of the leaf members 42 as shown in FIG. 2, and substantially parallel with the axis A. Preferably, the leaf members 42 are disposed at an acute angle a relative to the position of the leaf members 42 in the first position, as shown in FIG. 3. The contact surfaces 44 of oppositely disposed leaf members 42 are spaced apart a distance D2 when in the second position. As can be seen in FIGS. 2 and 3 the distance D2 is greater than the distance D1. Preferably, the contact surfaces 44 contact an outer surface of the container 34, as shown in FIG. 3.

As shown in FIGS. 2 and 3, the actuating mechanism 50 is manually operated by a vehicle occupant. It will be understood however, that if desired, the actuating mechanism can be actuated by any desired method, such as electronically actuated.

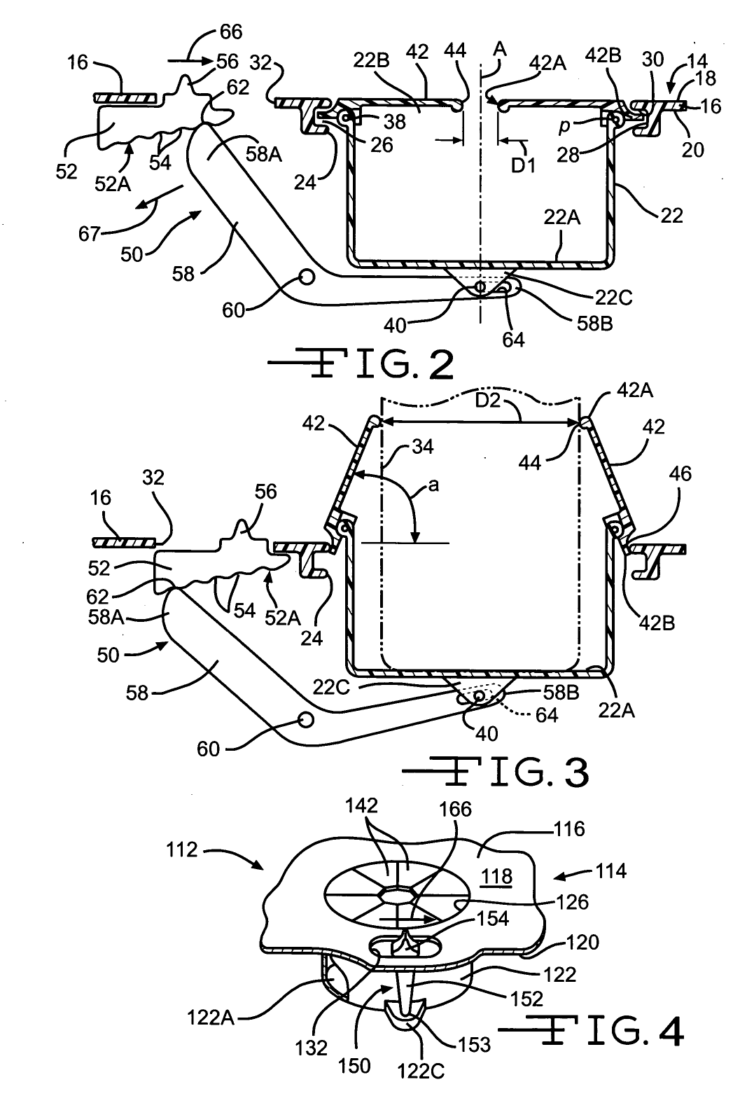

Referring now to FIGS. 4 through 10, and using like reference numbers to indicate corresponding parts, a second embodiment of the adjustable beverage holder for supporting an article according to the invention is illustrated generally at 112.

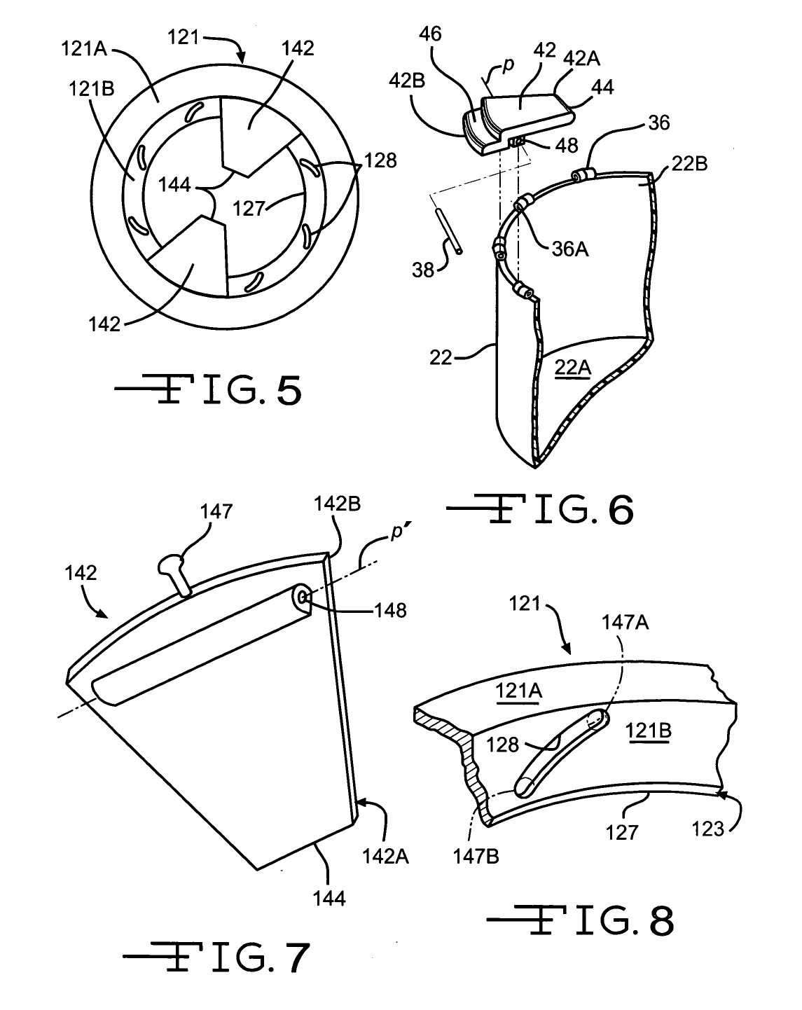

As shown in this embodiment, the beverage holder 112 is similar to the beverage holder 12 and may be mounted in a floor console, such as the floor console 10 illustrated in FIG. 1. The beverage holder 112 includes a housing 114. The housing 114 may be of any desired type and located at any desired position in the vehicle. The housing 114 may be attached to the vehicle by any desired means, such as threaded fasteners, by welding, or with adhesive. As shown in FIGS. 5 and 9, the housing 114 preferably includes a housing portion 116 having an ornamental or decorative surface 118 and an underside 120, a frame 121, and a body portion 122. As best shown in FIG. 9, the housing portion 116 includes an inner surface 124 defining a housing opening 126. Preferably, the housing opening 126 is substantially cylindrical in shape, although such is not required. The housing opening 126 can also have any other desired shape.

As best shown in FIG. 8, the frame 121 includes a substantially horizontal mounting surface 121A and a second surface 121B, preferably disposed at an obtuse angle b (as shown in FIG. 10) relative to the mounting surface 121A. The second surface 121B preferably has an arcuate cross section, as best shown in FIGS. 9 and 10. The second surface 121B includes an inner edge 123 defining a frame opening 127. Preferably, the frame opening 127 is substantially circular in shape, although such is not required. The frame opening 127 can also have any other desired shape. A plurality of substantially arcuate slots 128 are formed in the second surface 121 B. If desired, an actuator opening 132 can be formed in the housing portion 116. Preferably, the actuator opening 132 is formed adjacent the housing opening 26, as best shown in FIG. 4. The mounting surface 121A of the frame 121 is preferably attached to the underside 120 of the housing portion 116 about the housing opening 126. The frame 121 may be attached to the housing portion by any desired method, such as with an adhesive, by welding, or with threaded fasteners.

As best shown in FIGS. 9 and 10, the body portion 122 is disposed within the housing opening 126. The body portion 122 is preferably substantially cup shaped having a support surface 122A for horizonally supporting an object, such as the beverage container 34, as shown in FIG. 3, and an open end 122B opposite the support surface 122A. A plurality of pivot bosses (not illustrated but substantially identical to the pivot bosses 36 shown in shown in FIG. 6) extend axially outwardly from the open end 122B of the body portion 122. The bosses 36 include the first bore 36A for receiving the first pivot pin 38. A portion 122C of the body portion 122 extends radially outwardly from the support surface 122A. As will be explained herein, the body portion 122 is movable relative to the housing portion 116. Preferably, the body portion 122 is rotatably movable relative to the housing portion 116.

As best shown in FIGS. 5 and 7, a plurality of leaf members 142 are movably mounted about the open end 122B of the body portion 122. FIG. 5 is a top plan view of the frame 121 of the beverage holder 112 with all but two leaf members 142 removed. Preferably, the leaf members 142 are pivotally mounted about the open end 122B of the body portion 122. Each leaf member 142 includes a first end 142A defining a contact surface 144 for laterally supporting an object, such as the container 34, and a second end 142B opposite the first end 142A. A projection 147 extends radially outwardly from the second end 142B. Preferably, the projections 147 of the leaf members 142 are disposed within the slots 128.

Preferably, the leaf members 142 have the shape of a truncated triangle, as best shown in FIGS. 5 and 7. It will be understood however, that the leaf members 142 can have any desired shape, such as a substantially rectangular shape. A second bore 148 is formed in the leaf member 142 adjacent the second end 142B. The second bore 148 defines a pivot axis P′. Preferably, the leaf members 142 are movable between a first position as shown in FIG. 9 and a second position, as shown in FIG. 10. When in the first position, the leaf members 142 preferably define a substantially horizontal surface, as best shown in FIGS. 4 and 9.

Referring now to FIG. 4, an actuating mechanism 150 is disposed between the housing portion 116 and the body portion 122. The actuating mechanism 150 includes an arm 152 having a handle portion 154 extending outwardly of the actuator opening 132 and a second end 153 opposite the handle portion 154. Preferably, the second end 153 is disposed within a slot or opening in the radially outwardly extending portion 122C of the body portion 122.

In operation, a force is applied to the handle portion 154, causing the arm 152 to move in the direction of an arrow 166, and further causing the body portion 122 to rotate in a counter clockwise direction, as viewed in FIG. 4.

When in the first position, the projections 147 are disposed in an upper portion of the slots 128, as shown in FIG. 9, and further illustrated by a phantom line 147A in FIG. 8. As the body portion 122 rotates, the projections 147 of the leaf members 142 are caused to slide within the slots 128 from the first position toward the second position. When in the second position, the projections 147 are disposed in a lower portion of the slots 128, as shown in FIG. 10, and further illustrated by a phantom line 147B in FIG. 8.

As the body portion 22 rotates in the counter clockwise direction, the contact surfaces 144 are thereby caused to move vertically upwardly to the second position, as shown in FIG. 10. As shown in FIG. 4, the actuating mechanism 150 is manually operated by a vehicle occupant. It will be understood however, that if desired, the actuating mechanism can be actuated by any desired method, such as electronically actuated.

Referring now to FIGS. 11 through 14, and using like reference numbers to indicate corresponding parts, a third embodiment of the adjustable beverage holder for supporting an article according to the invention is illustrated generally at 212.

As shown in this embodiment, the beverage holder 212 is similar to the beverage holder 12 and may be mounted in a floor console, such as the floor console 10 illustrated in FIG. 1. The beverage holder 212 includes a housing 214. The housing 214 may be of any desired type and located at any desired position in the vehicle. The housing 214 may be attached to the vehicle by any desired means, such as threaded fasteners, by welding, or with adhesive. The housing 214 preferably includes a housing portion 216 having an ornamental or decorative surface 218 and an underside 220, an adjusting ring 221, and a body portion 222. As best shown in FIG. 11, the housing portion 216 includes an inner surface 224 defining a housing opening 226. Preferably, the housing opening 226 is substantially cylindrical in shape, although such is not required. The housing opening 226 can also have any other desired shape. If desired, an actuator opening 232 can be formed in the housing portion 216. Preferably, the actuator opening 232 is formed adjacent the housing opening 226, as best shown in FIGS. 1 and 11.

The body portion 222 is disposed within the housing opening 226. The body portion 222 is preferably substantially cup shaped having a support surface 222A for horizonally supporting an object, such as the beverage container 34, as shown in FIG. 3, and an open end 222B opposite the support surface 222A. A plurality of pivot bosses (not illustrated but substantially identical to the pivot bosses 36 shown in shown in FIG. 6) extend axially outwardly from the open end 222B of the body portion 222. A circumferential body arm 227 extends radially outwardly from the body portion 222 adjacent the open end 222B. The body arm 227 defines a substantially horizontal ring engagement surface 228, and a mounting surface 229. The mounting surface 229 of the body arm 227 is preferably attached to the underside 220 of the housing portion 216 radially outward of the housing opening 226. The body arm 227 may be attached to the housing portion by any desired method, such as with an adhesive, by welding, or with threaded fasteners.

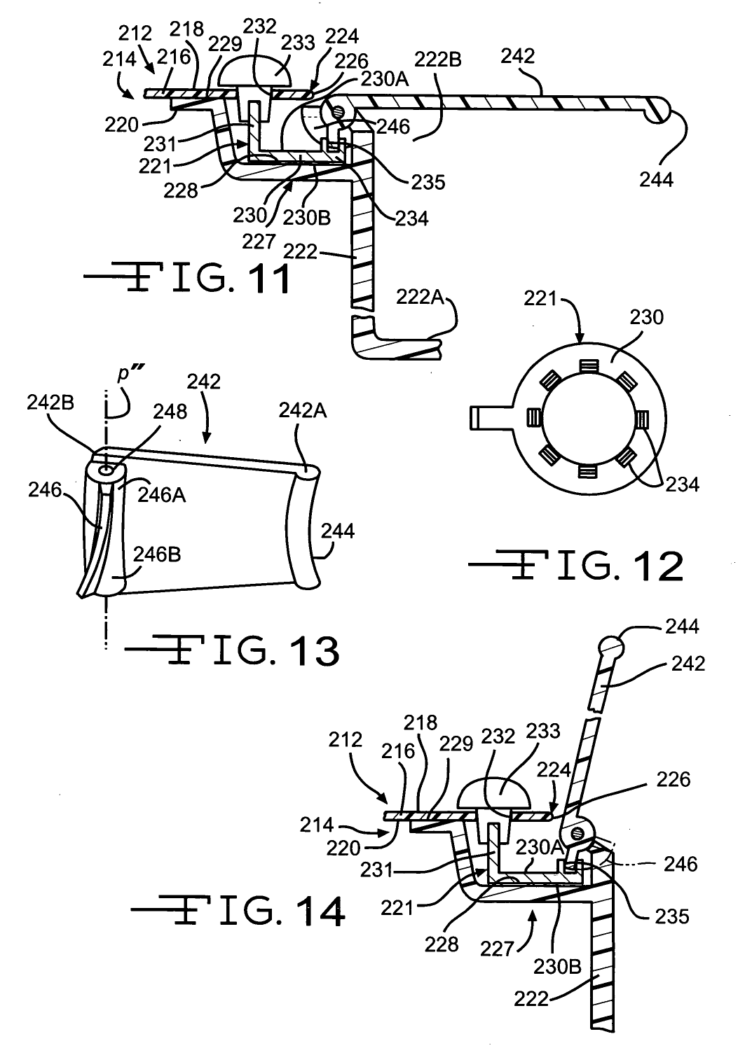

As best shown in FIGS. 11 and 12, the adjusting ring 221 includes a substantially annular body 230 having an upper surface 230A and a lower surface 230B. A ring arm 231 extends radially outwardly from the body 230 and includes a handle portion 233. A plurality of engagement bosses 234 extend upwardly (as viewed in FIG. 11) and is disposed circumferentially about the upper surface 230A. Each engagement boss 234 includes a slot 235. The adjusting ring 221 is preferably disposed on the body arm 227 such that the lower surface 230B slidably engages the ring engagement surface 228.

As best shown in FIG. 11, a plurality of leaf members 242 are movably mounted about the open end 222B of the body portion 222. Preferably, the leaf members 242 are pivotally mounted about the open end 222B of the body portion 222. As shown in FIG. 13, each leaf member 242 includes a first end 242A defining a contact surface 244 for laterally supporting an object, such as the container 34, and a second end 242B opposite the first end 242A. A screw flight 246 is formed at the second end 242B of the leaf member 242 and includes a first flight end 246A and a second flight end 246B.

Preferably, the leaf members 242 have the shape of a truncated triangle, as best shown in FIGS. 12 and 13. It will be understood however, that the leaf members 242 can have any desired shape, such as a substantially rectangular shape. A second bore 248 is formed in the leaf member 242 adjacent the second end 242B. The second bore 248 defines a pivot axis P″.

Preferably, the leaf members 242 are movable between a first position as shown in FIG. 11 and a second position, as shown in FIG. 14. When in the first position, the leaf members 242 preferably define a substantially horizontal surface, as best shown in FIG. 11. In the first position, the first flight end 246A is disposed within the slot 235, as best shown in FIG. 11. In the second position, the second flight end 246B is disposed within the slot 235, as best shown in FIG. 14.

In operation, a force (in a clockwise direction as viewed in FIG. 12) is applied to the handle portion 233 of the ring 221, causing the ring 221 to slide against the ring engagement surface 228. As the ring 221 rotates, the slot 235 slides along flight 246 causing the leaf member 242 to pivot upwardly toward the second position, as shown in FIG. 14. The contact surfaces 244 are thereby also caused to move vertically upwardly to the second position, as shown in FIG. 14. As shown in FIGS. 11 and 15, the adjusting ring 221 is manually operated by a vehicle occupant. It will be understood however, that if desired, the adjusting ring 221 can be actuated by any desired method, such as electronically actuated.

The exemplary embodiments illustrated show the leaf members 42, 142, 242 pivotally attached to the body portions 22, 122, 222. It will be understood however, that the leaf members 42, 142, 242 need not be pivotally attached to the body portions 22, 122, 222. For example, as best shown in FIG. 9A, the leaf members 142′ may be pivotally connected to one another, such as about a pivot axis p1, wherein the open end 122B′ of the body portion 122′ slidingly engages the leaf members 142′. Upward movement of the body portion 122′ then causes the open end 122B′ to slide along the leaf members 142′, urging the leaf member to pivot upwardly as herein described.

One advantage of the present invention is that when the leaf members 42, 142, 242 are moved from the closed to the open position, the contact surfaces 44, 144, 244 are caused to move vertically upwardly and relatively away from one another. The contact surfaces 44, 144, 244 thereby provide lateral support to an object, such as the container 34.

Another advantage of the invention is that the contact surfaces 44, 144, 244 can be moved vertically upwardly to define a plurality of desired open positions, only one of which is illustrated in the exemplary embodiments shown in FIGS. 3, 10, and 14. The holders 12, 112, 212 thereby allow containers of more than one diameter or circumferential size, and more than one vertical height, to be supported within any one holder 12, 112, 212.

The principle and mode of operation of this invention have been described in its preferred embodiments. However, it should be noted that this invention may be practiced otherwise than as specifically illustrated and described without departing from its scope.

1. A holder for supporting an article in a vehicle, the holder comprising:
a housing having a support surface for supporting an article, wherein said housing defines a vertical axis; and
a plurality of leaf members movably mounted relative to the housing, each said leaf member having an end defining a contact surface for laterally supporting the article,
wherein said leaf members are movable between a first position and a second position, such that when said leaf members are moved from the first position to the second position, said contact surfaces are caused to move relatively away from one another.

2. The holder according to claim 1, wherein when said leaf members are moved from the first position to the second position, said contact surfaces are caused to move vertically.

3. The holder according to claim 2, wherein when said leaf members are moved from the first position to the second position, said contact surfaces are caused to move vertically upwardly.

4. The holder according to claim 1, wherein in the first position said leaf members define a substantially horizontal surface.

5. The holder according to claim 4, wherein in the second position said leaf members are disposed at an acute angle relative to the first position.

6. The holder according to claim 4, wherein in the second position said contact surfaces are disposed at a greater distance from one another and vertically upward relative to the first position.

7. The holder according to claim 1, further including an actuating mechanism operatively connected to said leaf members, said actuating mechanism for moving said leaf members between the first and second positions.

8. The holder according to claim 1, wherein said plurality of leaf members is pivotally mounted relative to said housing.

9. The holder according to claim 1, said housing further including a housing portion and a body portion, said body portion movable relative to said housing portion, wherein movement of said body portion causes said leaf members to move between the first and second positions.

10. The holder according to claim 9, wherein said body portion is axially movable relative to said housing portion.

11. The holder according to claim 9, wherein said body portion is rotatably movable relative to said housing portion.

12. The holder according to claim 9, further including an actuating mechanism operatively connected to said body portion, said actuating mechanism for moving said body portion.

13. The holder according to claim 9, wherein said plurality of leaf members is pivotally mounted relative to said body portion.

14. The holder according to claim 9, wherein movement of said body portion causes said body portion to directly engage said leaf members thereby urging said leaf members between the first and second positions.

15. The holder according to claim 9, wherein said body portion is substantially cup shaped having a support surface and an open end opposite said support surface.

16. The holder according to claim 1, wherein said leaf members move substantially simultaneously between the first and second positions.

17. The holder according to claim 1, wherein each of said plurality of leaf members is disposed adjacent to another of said plurality of leaf members.

18. A holder for supporting an article in a vehicle, the holder comprising:
a housing having a support surface for supporting an article, wherein said housing defines a vertical axis;
a plurality of leaf members pivotally mounted relative to the housing, each said leaf member having a contact surface for laterally supporting the article; and
an actuating mechanism operatively connected to said holder,
wherein said leaf members are pivotally movable between a first position and a second position, such that when said leaf members are moved from the first position to the second position, said contact surfaces are caused to move relatively away from one another, and
wherein said actuating mechanism operates to move said leaf members between the first and second positions.

19-20. (canceled)

21. The holder according to claim 1, wherein said plurality of leaf members include a curved screw flight slidably engaged with said actuating mechanism, wherein when said actuating mechanism is operated to move, movement of said actuating mechanism causes said plurality of leaf members to move between the first and second positions.

22. The holder according to claim 21, wherein said actuating mechanism is rotatably mounted relative to said housing.
